(19) United States
(12) Patent Application Publication
(10) Pub. No.: US 2005/0174319 A1
(43) Pub. Date: Aug. 11, 2005

(54) Computer system and control method thereof

(76) Inventor: Soon-hoon Hwang, Yongin-si (KR)

Correspondence Address: STANZIONE & KIM, LLP, 1740 N STREET, N.W., FIRST FLOOR, WASHINGTON, DC, 20036, US

(21) Appl. No.: 10/944,751

(22) Filed: Sep. 21, 2004

(30) Foreign Application Priority Data
Feb. 7, 2004 (KR) 2004-8126

(51) Int. Cl. G09G 3/36

(52) U.S. Cl. 345/102

(57) ABSTRACT

The general inventive concept relates to a computer system comprising an input part, a computer main body and a display having a backlight, the computer main body comprising a video card provided with a data transmitter to transmit data to the display, a system operating part to check whether an input event is generated through the input part and to generate an input event-generating signal and an input event not-generating signal, an event checker to catch the input event not-generating signal if the system operating part generates the input event not-generating signal; and a computer controller to make the input event not-generating signal transmit to the display through the data transmitter when the input event not-generating signal is transmitted from the event checker, the display comprising a display controller to make the backlight keep turned off if the input event not-generating signal is transmitted to the display controller.

### CROSS-REFERENCE TO RELATED APPLICATIONS

This application claims the benefit of Korean Patent Application No. 2004-8126, filed Feb. 07, 2004, in the Korean Intellectual Property Office, the disclosure of which is incorporated herein by reference.

### BACKGROUND OF THE INVENTION

1. Field of the Invention

The general inventive concept relates to a computer system and a control method thereof, and more particularly, to a computer system in which a backlight of a display is automatically turned on/off depending on a type of an input event signal transmitted through an input part, and a control method thereof.

2. Description of the Related Art

Generally, a computer system comprises an input part, such as a keyboard or a mouse, a computer main body to process predetermined data based on a signal of the input part, and a display to display a processed result of data of the computer main body to a user.

The display displays the same picture in a predetermined period of time, if no input event is generated from the input part in a predetermined period of time, which may cause damage of display elements. To avoid this problem, a screen saver is displayed on the display to protect a display panel.

Here, the screen saver protects the display panel itself by preventing the same picture from being displayed for a predetermined period of time. However, the screen saver doesn't play a role in saving an electrical power of the display.

Further, if a user turns off the display to save the electrical power, the electrical power of the whole display is cut off. Here, if the display is a combination audio and video monitor, the display cannot display a picture, nor can it output a sound.

### SUMMARY OF THE INVENTION

Accordingly, it is an aspect of the present general inventive concept to provide a computer system in which a backlight of a display is automatically turned on/off depending on a type of an input event signal transmitted through an input part, and a control method thereof.

Additional and/or other aspects and advantages of the general inventive concept will be set forth in part in the description which follows and, in part, will be obvious from the description, or may be learned by practice of the invention.

The foregoing and/or other aspects of the present general inventive concept are achieved by providing a computer system that may comprise an input part, a computer main body, and a display having a backlight. The computer main body may comprise a video card provided with a data transmitter to transmit data to the display, a system operating part to check whether an event is performed at the input part, and to generate an input event-generating signal and an input event not-generating signal, an event checker to receive the input event not-generating signal if the system operating part generates the input event not-generating signal, and a computer controller to transmit the input event not-generating signal to the display through the data transmitter when the input event not-generating signal is transmitted from the event checker. The display may comprise a display controller to control the backlight to be turned off if the input event not-generating signal is transmitted to the display controller.

According to an aspect of the general inventive concept, the event checker may receive the input event-generating signal when the system operating part generates the input event-generating signal, the computer controller may transmit the input event-generating signal to the display through the data transmitter when the input event-generating signal is transmitted from the event checker, and the display controller may control the backlight to be maintained in an off state when the input event-generating signal is transmitted to the display controller.

According to another aspect of the general inventice concept, the display may further comprise an OSD controller to display an OSD, and a display input part. The display controller may control the OSD controller to display an OSD comprising a backlight automatic on/off function setting menu to set a backlight automatic on/off function to automatically turn on/off the backlight according to a transmission of the input event generating/not-generating signal when an OSD setting signal is transmitted to the display controller from the display input part.

According to yet another aspect of the general inventive concept, the backlight automatic on/off function setting menu may comprise an activating button and an inactivating button to activate and inactivate of the backlight automatic on/off function, respectively, and the display controller may perform the backlight automatic on/off function when a user selects the activating button through the display input part.

According to still another aspect of the general inventive concept, the display may further comprise a sound output part to output an audio signal inputted from the computer main body.

According to still another aspect of the general inventive concept, the input event not-generating signal may be a signal to operate a screen saver.

The foregoing and/or other aspects of the present general inventive concept may also be achieved by providing a control method of a computer system having an input part, a display having a backlight, and a computer main body having a video card provided with a data transmitter to transmit data to the display, the control method comprising checking whether an input event is performed at the input part, generating an input event not-generating signal when an input event is not performed within a predetermined period of time, receiving a generated input event not-generating signal, transmitting the input event not-generating signal to the display through the data transmitter, and maintaining the backlight in an off state when the input event not-generating signal is transmitted.

According to an aspect of the general inventive concept, the control method may further comprise generating the input event-generating signal when an input event is performed at the input part, receiving the generated input event-generating signal, transmitting the input event-generating signal to the display through the data transmitter, and maintaining the backlight in an on state when the input event-generating signal is transmitted.

According to another aspect of the general inventive concept, the control method may further comprise generating an OSD setting signal, displaying an OSD comprising a backlight automatic on/off function setting menu to set a backlight automatic on/off function to automatically turn on/off the backlight according to a transmission of the input event generating and/or not-generating signal, and performing the backlight automatic on/off function if the backlight automatic on/off function is activated through the OSD.

According to another aspect of the general inventive concept, the input event not-generating signal may be an signal to operate a screen saver.

### BRIEF DESCRIPTION OF THE DRAWINGS

These and/or other aspects and advantages of the general inventive concept will become apparent and more readily appreciated from the following description of the preferred embodiments, taken in conjunction with the accompanying drawings of which:

FIG. 1 is a block diagram of a computer system according to an embodiment of the present general inventive concept; and

FIG. 2 is a control flow chart of the computer system of FIG. 1 according to another embodiment of the general inventive concept.

### DETAILED DESCRIPTION OF THE PREFERRED EMBODIMENTS

Reference will now be made in detail to the preferred embodiments of the present general inventive concept, examples of which are illustrated in the accompanying drawings, wherein like reference numerals refer to the like elements throughout. The embodiments are described below in order to explain the present general inventive concept by referring to the figures.

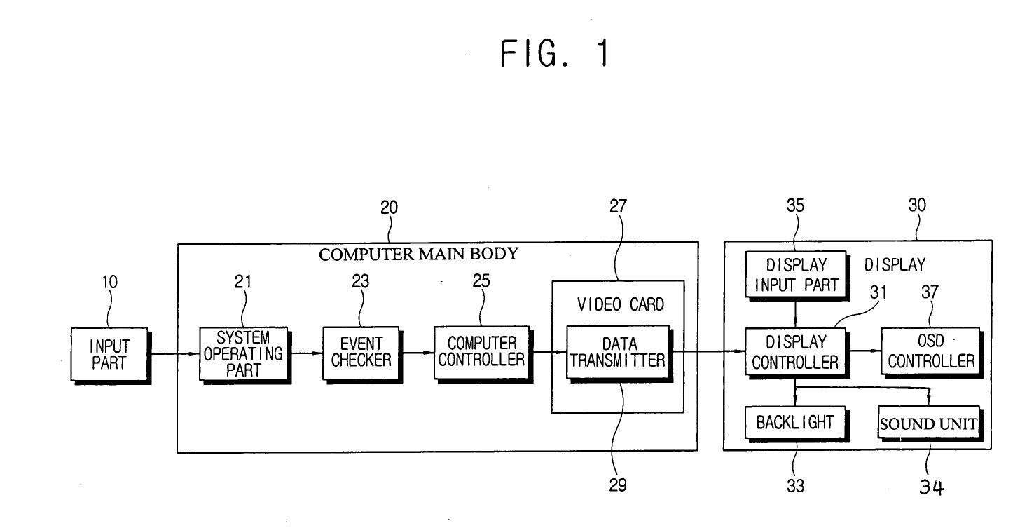

As shown in FIG. 1, a computer system according to an embodiment of the present general inventive concept may comprise an input part 10, a computer main body 20, and a display 30 having a backlight 33.

The computer main body 20 may incldue a video card 27, a system operating part 21, an event checker 23 and a computer controller 25. The display 30 may comprise a display controller 31, a display input part 35 and an onscreen display (OSD) controller 37 to display an OSD.

The video card 27 may comprise a data transmitter 29 as a communication channel between the computer main body 20 and the display 30. The computer main body 20 can transmit data to the display 30 through the data transmitter 29. For example, the computer main body 20 may use DDC (display data channel)-COMMUNICATION as a communication protocol for a communication with the display part 30. That is, the computer main body 20 can transmit data to the display 30 using two pins of a D-SUB connector provided in the video card 27.

The system operating part 21 can determine whether an input event is performed at the input part 10, such as a keyboard, a mouse or the like. If the input event is performed, the system operating part 21 can generate an input event-generating signal, and if no input event is generated, the system operating part 21 can generate an input event not-generating signal. Generally, if a screen saver is set in a computer system, a system operating program, such as Microsoft Windows, can generate a signal to operate the screen saver if no input event is performed at the keyboard, the mouse, or the like within a predetermined period of time. Here, the signal to operate the screen saver may be the input event not-generating signal.

The event checker 23 can receive the input event not-generating signal if the system operating part 21 generates the input event not-generating signal, while the event checker 23 can receive the input event-generating signal if the system operating part 21 generates the input event-generating signal. Then, the event checker 23 can transmit the input event not-generating signal or the input event-generating signal to the computer controller 25.

The computer controller 25 can transmit the input event not-generating signal to the display 30 through the data transmitter 29, such as the D-SUB connector, if the input event not-generating signal is transmitted to the computer controller 25. The computer controller 25 can transmit the input event generating signal to the display 30 through the data transmitter 29 such as the D-SUB connector, if the input event generating signal is transmitted to the computer controller 25.

The display controller 31 can control the backlight 33 to be maintained in an off state if the input event not-generating signal is transmitted, while the display controller 31 controls the backlight 33 to be maintained in an on state if the input event generating signal is generated. The display controller 31 can control the OSD controller 37 to display an OSD comprising a backlight automatic on/off function setting menu which sets a backlight automatic on/off function to turn on/off the backlight 33 according to a transmission of the input event generating signal or not-generating signal when an OSD setting signal is transmitted from the display input part 35 such as a key button or a remote controller.

The backlight automatic on/off function setting menu may comprise an activating button and an inactivating button of the backlight automatic on/off function. The display controller 31 can perform the backlight automatic on/off function if the user selects the activating button through the display input part 35. For example, if a user selects the activating button, the display controller 31 can control the backlight 33 to be maintained in the off state when the event input not-generating signal is transmitted, and to be maintained in the on state when the event input generating signal is transmitted.

If a predetermined period of time has passed since a user performed an input event at the input part 10, such as the keyboard, the input event not-generating signal can be generated at the system operating part 21. Then, if the backlight 33 of the display 30 is turned on, the display controller 31 can turn off the backlight 33 and maintain the backlight 33 in the off state. At this time, if the user performs the input event using the keyboard or the mouse, the system operating part 21 can generate the input event-generating signal. Then, the backlight 33 of the display 30 can be turned on and be maintained in the on state. Therefore, a computer system may be provided in which the backlight 33 of the display 30 is automatically turned on/off depending on the type of the input event is performed at the input part 10.

If the display 30 further comprises a sound output-part (sound unit 34), such as a speaker, to output an inputted audio signal, the display controller 31 can cut off only the electrical power supplied to the backlight 33 when the input event not-generating signal is transmitted to the display controller 31. That is, if the backlight 33 is turned off, a picture of the display 30 can be removed from the display panel, but the electrical power supplied to the speaker can be continually supplied. Thus, the computer system can have a combination video and audio display 30 in which a sound can be continually output even if the picture is not displayed.

According to this embodiment of the present general inventive concept, the sound unit 34 as a sound output part is illustrated as being installed in the display 30. However, the sound output-part of this embodiment of the general inventive concept is not limited to the sound unit 34, but can be any other type of sound output-part that performs the purpose intended herein. The sound unit 34 can be installed in the computer main body 20. That is, the sound unit 34 can be formed integrally with one of the computer main body 20 and the display 30 or can be installed outside the computer main body 20 and the display 30 as an external device connected to the computer main body 20 or the display 30. The sound unit 34 can also be connected to the computer controller 25 of the computer main body 20 rather than the display controller 31 of the display.

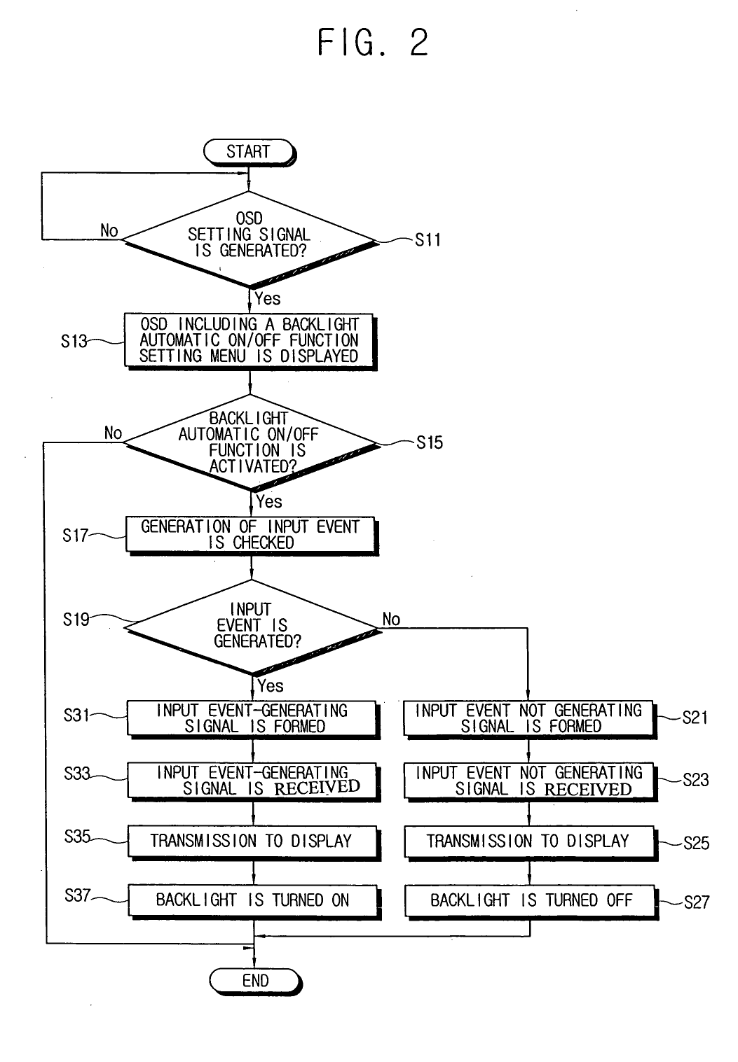

Hereinbelow, referring to FIG. 2, a control flow of the computer system of FIG. 1 according to another embodiment of the present general inventive concept is described below.

If the OSD setting signal is generated from the display input part 35, such as a key button or a remote controller, at operation S11, the OSD comprising the backlight automatic on/off function-setting menu can be displayed on a picture of the display 30 at operation S13.

The backlight automatic on/off function-setting menu may comprise the activating button and the inactivating button of the backlight automatic on/off function. Thus, the display controller 31 can check whether the button selected by a user through the display input part 35 is the activating button or the inactivating button, and can control performance of the backlight automatic on/off function if the activating button is selected at operation S15.

The system operating part 21 can check whether an input event is performed at the input part 10 at operations S17 and S19. At this time, if no input event is performed within a predetermined period of time, the system operating part 21 can generate the input event not-generating signal at operation S21.

The event checker 23 can receive the generated input event not-generating signal and transmit it to the display 30 at operations S23 and S25. At this time, the generated input event not-generating signal can be transmitted to the display 30 through the data transmitter 29, such as D-SUB connector provided in the video card 27.

The display controller 31 can turn off the backlight 33 if the input event not-generating signal is transmitted to the display controller 31 at operation S27, which causes a power saving of the display 30, such as a liquid crystal display (LCD).

If a user performs an operation at the input part 10, such as the keyboard, the mouse or the like, the system operating part 21 can generate the input event-generating signal corresponding to the user's operation at operation S31.

The event checker 23 can receive the generated input event-generating signal and transmit it to the display 30 at operations S33 and S35. The generated input event-generating signal can be transmitted to the display 30 through the data transmitter 29 such as the D-SUB connector.

If the input event-generating signal is transmitted to the display controller 31, the display controller 31 can turn on the backlight 33 at operation S37.

Thus, in the computer system, the backlight 33 of the display 30 can be automatically turned on/off according to a determination of whether the input event generates through the input part 10.

Further, if the display 30 of the computer system is a combination audio and video monitor comprising a sound output part such as a speaker, the sound can be continually output although the backlight 33 is turned off and the picture is removed from the display panel. Accordingly, the computer system may have the combination audio and video display 30 in which the sound is continually output while the picture is not displayed.

As described above, the present general inventive concept provides a computer system in which a backlight of a display can be automatically turned on/off according to a determination of whether the input event signal is generated by the input part.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

1. A computer system comprising:
an input part;
a computer main body; and
a display having a backlight,
wherein the computer main body comprising,
a video card provided with a data transmitter to transmit data to the display,
a system operating part to check whether an input event is generated through the input part and to generate an input event-generating signal and an input event not-generating signal,
an event checker to receives the input event not-generating signal if the system operating part generates the input event not-generating signal, and
a computer controller to transmit the input event not-generating signal to the display through the data transmitter when the input event not-generating signal is received from the event checker; and
the display comprising,
a display controller to control the backlight to be turned off if the input event not-generating signal is transmitted to the display controller.

2. The computer system according to claim 1, wherein:
the event checker receives the input event-generating signal when the system operating part generates the input event-generating signal;
the computer controller transmits the input event-generating signal to the display through the data transmitter when the input event-generating signal is received from the event checker; and
the display controller controls the backlight to be turned off if the input event-generating signal is transmitted to the display controller.

3. The computer system according to claim 2, wherein the display further comprises an OSD controller to display an OSD and a display input part, and the display controller controls the OSD controller to display an OSD including a backlight automatic on/off function setting menu to set a backlight automatic on/off function to automatically turn on/off the backlight according to a transmission of the input event generating/not-generating signal when an OSD setting signal is transmitted to the display controller from the display input part.

4. The computer system according to claim 3, wherein the backlight automatic on/off function setting menu comprises an activating button and an inactivating button to activate and inactivate of the backlight automatic on/off function, and the display controller performs the backlight automatic on/off function when the activating button is selected through the display input part.

5. The computer system according to claim 1, wherein the display further comprises a sound output part to output an audio 'signal inputted from the computer main body.

6. The computer system according to claim 1, wherein the input event not-generating signal is an signal to operate a screen saver.

7. A control method of a computer system comprising an input part, a display having a backlight and a computer main body having a video card provided with a data transmitter to transmit data to the display, the control method comprising:
checking whether an input event is performed at the input part;
generating an input event not-generating signal when an input event is not performed within a predetermined period of time;
receiving a generated input event not-generating signal;
transmitting the input event not-generating signal to the display through the data transmitter; and
controlling the backlight to be turned off when the input event not-generating signal is transmitted.

8. The control method according to claim 7, further comprising:
generating the input event-generating signal when an input event is performed at the input part;
receiving the generated input event-generating signal;
transmitting the input event-generating signal to the display through the data transmitter; and
controlling the backlight to be turned on when the input event-generating signal is transmitted.

9. The control method according to claim 8, further comprising:
generating an OSD setting signal;
displaying an OSD comprising a backlight automatic on/off function setting menu to set a backlight automatic on/off function to automatically turn on/off the backlight according to a transmission of the input event generating/not-generating signal; and
performing the backlight automatic on/off function if the backlight automatic on/off function is activated through the OSD.

10. The control method according to claim 7, wherein the input event not-generating signal is an signal to operate a screen saver.

11. A computer system comprising an input part, a computer main body, and a display, wherein:
the computer main body selectively generates an input event not-generating signal; and
the display stops displaying a picture upon receiving the input event not-generating signal while the computer main body is turned on.

12. The computer system according to claim 11, further comprising:
a sound unit to generate sound.

13. The computer system according to claim 12, wherein the sound unit is maintained in an on state regardless of an on and off state of the picture.

14. The computer system according to claim 13, wherein the main computer body outputs signals corresponding to the picture and the sound to the display and the sound unit, respectively, and the display stops displaying the picture according to the input event not-generating signal while the sound unit continues to generate the sound according to the signal from the computer main body.

15. The computer system according to claim 12, wherein the display and the sound unit are formed in an integral body.

16. The computer system according to claim 11, wherein the computer main body generates signals corresponding to sound and picture to display the picture and output the sound when the input event not-generating signal is not received , and controls the display not to display the picture when the display receives the input event not-generating signal.

17. The computer system according to claim 11, wherein the computer main body generates an input event-generating signal, and the display is turned on to display the picture upon receiving the input event-generating signal.

18. The computer system according to claim 17, wherein the computer main body generates the input event-generating signal and the input event not-generating signal according to an input signal inputted from the input part.

19. The computer system according to claim 18, wherein the input event not-generating signal comprises a screen saver signal generated from the computer main body.

20. The computer system according to claim 11, wherein the display comprises a backlight and the display turns off the backlight to prevent generation of the picture upon receiving the the input event not-generating signal.

21. The computer system according to claim 20, wherein the display generates a screen to set a backlight automatic on/off function, and the display is turned off according to the input event not-generating signal and a selection of the backlight automatic an/off function.

22. A computer system comprising:
an input part;
a computer main body to selectively generate an input event not-generating signal; and
a display unit having a backlight that turns off upon receiving the input event not-generating signal from the computer main body to stop a picture from being displayed on the computer system.

23. A control method of a computer system having an input part, a computer main body, and a display, the method comprising:
selectively generating an input event not-generating signal; and
terminating displaying a picture upon receiving the input event not-generating signal while the computer main body is turned on.
